(19) United States
(12) Patent Application Publication
(10) Pub. No.: US 2003/0213766 A1
(43) Pub. Date: Nov. 20, 2003

(54) Telescopic arm

(75) Inventor: Yukio Kinoshita, Tsurugashima-shi (JP)

Correspondence Address: BROWDY AND NEIMARK, P.L.L.C., 624 NINTH STREET, NW, SUITE 300, WASHINGTON, DC, 20001-5303, US

(73) Assignee: Komatsu Utility Europe S.p.A., Noventa Vicentina (IT)

(21) Appl. No.: 10/160,168

(22) Filed: Jun. 4, 2002

(30) Foreign Application Priority Data
May 15, 2002 (EP) EP-02425303.1

(51) Int. Cl. B66C 23/04

(52) U.S. Cl. 212/349

(57) ABSTRACT

Telescopic arm comprising a first base section (2), a second intermediate section (3) inserted in said base section, and a third terminal section (4) inserted in the intermediate section. An extension cylinder (6) is operatively associated between the first and the second section (2), (3) to actuate the second section (3) between a retracted position in which it is inserted in the first section (2), and an extended section in which it projects from the first section (2). The arm further comprises a first pulley (9) integral with an outer end (5) of the second section (3) and a first chain (8) transmitted by the first pulley (9), which slides in part between the first and the second section (3) and in part between the second and the third section (4), and which has a first end (14) associated internally to the first section (2) and a second end (15) associated to the third section (4) to extend the third section (4) relative to the second section (3) when the second section (3) is extended relative to the first section (2), The aim is also provided with return means (22) to cause the third section (4) to return inside the second section (3) when the second section (3) is made to return inside the first section (2). A covering case (21) is mounted in removable fashion externally to the second section (3) to cover and protect the first chain (8) When the second section (3) is extended relative to the first section (2).

### BACKGROUND OF THE INVENTION

The present invention relates to a telescopic arm comprising the characteristics expressed in the preamble to claim 1.

The present invention is aimed at all Fields in which telescopic arms are used, but in particular to the sector of crane trucks and of telescopic lifts, and it is applicable to telescopic arms having at least three sections.

Today, many types of telescopic arms are used, as well as many ways to extend them.

A first type currently employed provides for the use of two opposite hydraulic cylinders mounted internally or externally to the arm itself. A first cylinder operates between the first and the second section, whilst the other one between the second and the third section.

This solution, in addition to having a sizeable cost, also needs appropriate valve systems to obtain the simultaneous extension of the second section relative to the first section and of the third section relative to the second section, and hence has a certain constructive complexity.

An alternative embodiment provides for the use of a single extension cylinder mounted between the first and the second section, of an extension chain, and of a transmission chain that cause the movement of the third section simultaneously with the second section.

The first chain has a first end fastened externally to the first section, slides around a first transmission pulley integral with the outer end of the second section, and is fastened at the other end to the third section. The extension of the second section relative to the first section causes the first transmission pulley to move away from the first end of the chain and hence the third section to egress from the second.

Similarly, the return of the third section is assured by a second chain inserted inside the arm, which has its own ends fastened one to the first and one to the third section, and which is wound about a second transmission pulley integral with the inner end of the second section.

The main drawback of this solution is given by the exposure of the first chain to the elements and dirt, which requires periodic the cleaning and greasing of the chain.

An additional solution currently employed, described in U.S. Pat. No. 5,494,397, provides for a different embodiment of the first chain, with both the cylinder and the second chain and second pulley unaltered with respect to the case described above.

In this solution, the first chain is completely inserted inside the telescopic arm, being as before fastened between the first and the third section, and wound around the second pulley that is integral with the second section and positioned in correspondence with its outer end.

Although in this case the chain is protected against dirt and the elements, there is the drawback that it is difficult to access, so that it is necessary to disassemble the arm when maintenance operations are required.

This problem is exacerbated by the fact that the first chain is the one subjected to greater stresses when lifting the load, and therefore it is necessary to check its condition periodically.

### SUMMARY OF THE INVENTION

In this situation the technical task constituting the basis for the present invention is to obtain a telescopic arm that overcomes the aforementioned drawbacks.

In particular, the technical task of the present invention is to obtain a telescopic arm on which it is easy to intervene to perform inspection and/or maintenance operations, but which in addition requires little maintenance relative to those currently in use.

The specified technical task and the indicated aims are substantially achieved by a telescopic arm, as described in the accompanying claims.

### BRIEF DESCRIPTION OF THE DRAWINGS

Further features and advantages of the invention shall become more readily apparent from the detailed description of a preferred, but not exclusive, embodiment, illustrated in the accompanying drawings, in which:

FIG. 1 schematically shows a longitudinal section view of a telescopic arm according to the present invention in shortened condition;

FIG. 2 shows the arm of FIG. 1 in extended condition.

### DESCRIPTION OF THE PREFERRED EMBODIMENTS

With reference to the aforementioned figures, the reference number 1 globally indicates a telescopic arm according to the present invention.

The telescopic arm 1 comprises at least three sections 2, 3, 4 inserted in sliding fashion one inside the other, and identified as a first base section 2 (the one nearer the attachment point of the arm 1 to a vehicle), a second intermediate section 3 inserted in the base section 2, and a third terminal section 4 able to be associated to an operative organ (such as a lifting fork) and inserted in the intermediate section 3 in correspondence with an outer end 5 thereof.

The arm 1 is provided with an extension cylinder 6 and with appropriate extension means 7 that comprise a first chain 8 and a second pulley 9.

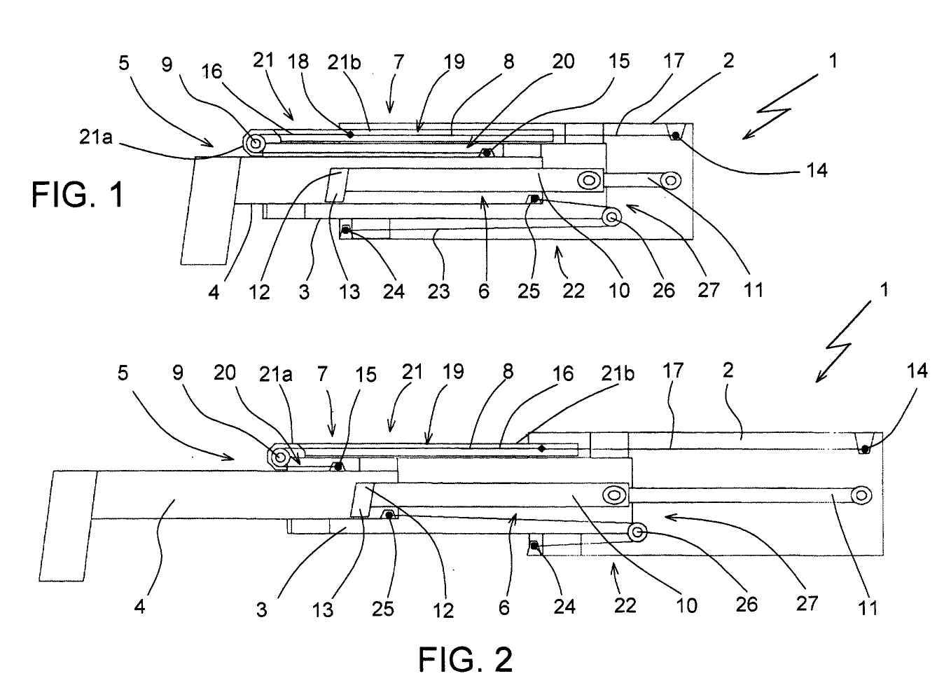

The extension cylinder 6 is operatively associated between the first and the second section 2, 3 to actuate the second section 3 between a retracted position in which it is inserted in the first section 2 (FIG. 1), and an extended position in which it projects from the first section 2 (FIG. 2).

In particular the extension cylinder 6, which in the illustrated embodiment is mounted internally to the arm 1, has an outer jacket 10 integral with the second section 3, and a piston 11 integral with the first section 2. The jacket 10 also has a terminal appendage 12, positioned at the opposite side relative to the piston 11, inserted in the third section 4 and carrying a sliding bearing 13 (shown only schematically in the accompanying figures) associated in sliding fashion inside the third session 4 itself.

In the illustrated embodiment, the first extension chain 8 has a first end 14 internally associated to the first section 2 and a second end 15 associated externally to the third section 4 to extend the third section 4 relative to the second section 3 when the second section 3 is extended relative to the first section 2.

Hereafter, the term “first chain” 8 shall mean two possible embodiments, a first embodiment in which the first chain 8 is constituted exclusively by a chain, and a second embodiment (shown schematically in the accompanying figures) in which the first chain 8 is constituted by an actual chain 16 and by a rigid rod 17 connected between the first end 18 of the actual chain 16 and the first section 2 of the arm 1. As shall become readily apparent below, said second solution yields advantages both in economic and in maintenance terms.

The First chain 8 then slides around the first transmission pulley 9 which is integral with the outer end 5 of the second section 3 externally relative to the third section 4.

In this way the first chain 8 has a first and a second mutually parallel segment 19, 20, the first segment 19 that extends from the first end 14 to the first transmission pulley 9 and the second segment 20 that goes from the first transmission pulley 9 to the second end 15.

The first segment 19 of the first chain 8 is externally associated to the second section 3 and slides at least in part between the first and the second section 2, 3.

The second segment 20 instead slides between the second and the third section 3, 4.

The telescopic arm 1 further comprises a covering case 21 mounted in removable fashion on the exterior of the second section 3 to cover and protect at least the segment of the first chain 8 that is external to the arm 1 when the second section 3 is extended relative to the first section 2.

As FIG. 2 shows, advantageously the case 21 also covers the first pulley 9, and, whatever the position of the sections 2, 3, 4 of the arm 1, it also covers part of the first chain 8 that is inserted between the first and the second section 2, 3.

Additionally, the case 21 recesses within the first section 2 together with the second section 3, whereto it is fastened.

At least two embodiments of the case 21 are then provided for. A first embodiment provides that the case 21 would be constituted by a single piece, whilst a second embodiment (shown in the enclosed figures) provides that the case 21 would be constituted by a first and a second piece 21a, 21b, respectively destined to cover the first pulley 9 and the first chain 8.

The arm 1 is provided with return means 22 to cause the third section 4 to return into the second section 3 when the second section 3 is made to return into the first section 2.

Said return means 22 are constituted by a second return chain 23 inserted internally to the arm 1 and having a first end 24 associated to the first section 2 and a second end 25 associated to the third section 4 and a second pulley 26 for the transmission of the second chain 23 integral with an inner end 27 of the second section 3.

In regard to the operation of the telescopic arm 1, the egress and return of the second section 3 relative to the first section 2 are determined by the action of the extension cylinder 6, whilst the simultaneous egress and return of the third section 4 relative to the second section 3 are determined respectively by the extension means 7 and by the return means 22.

When the extension cylinder 6 commands the extension of the second section 3, it causes a move of the first pulley 9 away from the point where the first chain 8 is fastened to the first section 2, so that also the second end 15 of the first chain 8 is thrust outwards, driving also the third section 4.

In similar fashion, when the extension cylinder 6 commands the return of the second section 3, it causes a move of the second pulley 26 away from the point where the second chain 23 is fastened to the first section 2 with a consequent inward drive of the third section 4.

The present invention achieves important advantages.

In the first place, the telescopic arm 1 in accordance with the present invention enables an easier access to the first chain 8 than currently used telescopic arms. To access the first chain 8, it is sufficient to extend the second section 3 and remove the case 21 if present.

Additionally, the embodiment complete with case 21 assures the protection of the first chain 8 against the elements and dirt, providing for a longer useful life of the chain and less need For maintenance.

Additionally, using a rigid rod 17 instead of a chain segment, production costs are lowered and mechanical strength is enhanced, which is particularly advantageous because the segment of the first chain 8 constituted by the rigid rod 17 is the only not directly accessible from outside the arm 1.

Using a rigid rod 17 the probability that the first chain may break inside the first section 2, i.e. where the maintenance intervention would not be easy, is negligible.

It should also be noted that the present invention is relatively easy to build and that the cost connected with implementing the invention is not very high relative to industry standards.

The invention thus conceived can be subject to numerous modifications and variations, without thereby departing from the scope of the inventive concept that characterises it.

All components can be replaced by other technically equivalent elements and in practice all materials used, as well as the shapes and dimensions of the various components, can be any depending on requirements.

What is claimed

1. Telescopic arm comprising:
at least three sections (2), (3), (4) inserted one inside the other in sliding fashion, a first base section (2), a second intermediate section (3) inserted in said base section (2), and a third terminal section (4) able to be associated to an operative organ and inserted in said intermediate section (3) in correspondence with its own outer end (5);
an extension cylinder (6) having an outer jacket (10) and an inner piston (11) and operatively associated between said first and second section (2), (3) to actuate the second section (3) between a retracted position in which it is inserted in the first section (2), and an extended position in which it projects from the first section (2);
a first extension chain (8) having a first end (14) associated internally to said first section (2) and a second end (15) associated to said third section (4) to extend said third section (4) relative to said second section (3) when said second section (3) is extended relative to said first section (2);
a first transmission pulley (9) of said first chain (8) integral with said second section (3);
return means (22) to cause said third section (4) to return inside said second section (3) when said second section (3) is made to return inside said first section (2);
characterised in that said first pulley (9) is integral with said outer end (5) of the second intermediate section (3) externally to said third section (4), and in that said first chain (8) is externally associated to said third section (4) and slides in part between said first and second section (3) and in part between said second and third section (3), (4).

2. Telescopic arm as claimed 1, characterised in that it further comprises a covering case (21) mounted in removable fashion outside said second section (3) to cover and protect said first chain (8) when the second section (3) is extended with respect to the first section (2).

3. Telescopic arm as claimed in claim 2 characterised in that said case (21) returns inside the first section (2) together with the second section (3).

4. Telescopic arm as claimed in claim 2 characterised in that said case (21) also covers said first pulley (9).

5. Telescopic arm as claimed in claim 4 characterised in that the case (21) is constituted by a single piece.

6. Telescopic arm as claimed in claim 4 characterised in that the case (21) is constituted by a first and a second piece (21a), (21b), respectively destined to cover the first pulley (9) and the first chain (8).

7. Telescopic arm as claimed in claim 1 characterised in that said jacket (10) of the cylinder (6) is internally integral with said second section (3), and in that said piston (11) is internally integral with said first section (2).

8. Telescopic arm as claimed in claim 7 characterised in that said jacket (10) has a terminal appendage (12) inserted in said third section (4) and carrying a sliding bearing (13) associated in sliding fashion to the third section (4).

9. Telescopic arm as claimed in claim 1 characterised in that said first chain (8) comprises a chain (16) and a rigid rod (17) connected in series, the chain being fastened to the third section (4) and to the rigid rod (17) and the rigid rod (17) being inserted internally to the first section (2) and fastened thereto.

10. Telescopic arm as claimed in claim 1 characterised in that said return means (22) comprise a second return chain (23) inserted internally to said arm (1) and having a first end (24) associated to said first section (2) and a second end (25) associated to said third section (4) and a second transmission pulley (26) of said second chain (23) integral with an inner end of said second section (3).
